(19) United States
(12) Patent Application Publication
(10) Pub. No.: US 2019/0060763 A1
(43) Pub. Date: Feb. 28, 2019

(54) INFORMATION PROCESSING DEVICE AND METHOD

(71) Applicant: Kabushiki Kaisha Sega Games doing business as Sega Games Co., Ltd., Tokyo (JP)

(72) Inventors: Kensuke Arai, Tokyo (JP); Hayato Hirai, Tokyo (JP); Takahiro Otomo, Tokyo (JP)

(73) Assignee: Kabushiki Kaisha Sega Games doing business as Sega Games Co., Ltd., Tokyo (JP)

(21) Appl. No.: 16/172,412

(22) Filed: Oct. 26, 2018

Related U.S. Application Data
(63) Continuation of application No. PCT/JP2017/011476, filed on Mar. 22, 2017.

(30) Foreign Application Priority Data
Apr. 27, 2016 (JP) 2016-088846

(51) Int. Cl. A63F 13/69; A63F 13/77; A63F 13/79

(52) U.S. Cl. CPC A63F 13/69; A63F 13/79; A63F 13/77

(57) ABSTRACT

An information processing device that executes a fusion game, includes: a content information storage that stores content information in which a plurality of resource contents, associated with each other in advance, are set corresponding to a fusion source content; a user information storage that stores user information including content associated with a user ID; a processor that: associates at least one of the plurality of contents, wherein the plurality of contents include any of the resource contents, with the user ID; when one of the resource contents is associated with the user ID, extracts: the fusion source content corresponding to the one resource content associated with the user ID and the resource contents corresponding to the extracted fusion source content, and sends a notification about the relationship between the extracted fusion source content and the extracted plurality of resource contents.

### TECHNICAL FIELD

The present invention relates to an information processing device and a method.

### BACKGROUND

There are known programs for causing a computer to execute a fusion game. In these fusion games, items (as an example of content) are possessed by a user, and item fusion is performed by using the items that serve as a plurality of resources (resource items) which have been associated with each other in advance, from among the items possessed by the user (see Patent Literature 1, for example).

Patent Literature 1: JP-A 2007-111319

In these fusion games, various kinds of resource items that can be used for item fusion are granted (provided) to the user. However, a user who is unfamiliar with the game may be given a resource item but do not know which items are related to the resource item. Therefore, the user may be unable to utilize that resource item for item fusion. The user therefore has to access a strategy site or the like on the Internet and investigate the relationship between the provided resource item and other items in detail.

According to one of more embodiments of the present invention, users are able to grasp the relationship between a resource content and other contents when a content as a resource has been provided.

### SUMMARY

One or more embodiments of the present invention include:

an information processing device that executes a fusion game in which content fusion is performed using fusion source content that serves as a fusion source and resource content that serves as a resource, said information processing device comprising:

a content information storage component that stores content information in which a plurality of resource contents that have been associated with each other in advance are set corresponding to fusion source content;

a user information storage component that stores user information including content possessed by a user;

a providing component that provides (grants) a user any of a plurality of contents including resource contents; and

a notification component that extracts (selects) fusion source content corresponding to the provided resource content and a plurality of resource contents corresponding to the fusion source content when the user possesses a resource content provided by the providing component, and sends the user a notification about the relationship between the extracted fusion source content and the plurality of resource contents.

Using this information processing device makes it easy for the user to grasp the relationship between a provided resource content and other contents when the resource content is provided, thus enabling efficient content fusion to be performed using that resource content.

Also, the notification component may give notification about the user's possession status with respect to each of the plurality of extracted resource contents when notifying about the relationship between the extracted fusion source content and the plurality of resource contents.

Consequently, when a resource content is provided, the user can easily grasp his own possession status of other resource contents that are related to the provided resource content.

Also, the device may further comprise a game advancing component that controls the progress of a fusion game in which a plurality of resource contents corresponding to fusion source content, from among the contents possessed by the user, are combined with the fusion source content, wherein the notification component gives a notification that guides the user to the fusion game on the condition that the user possesses all of the plurality of resource contents corresponding to the extracted fusion source content.

Consequently, when a resource content is provided, the user can easily grasp that the provided resource content can be used immediately in the fusion game.

Also, game events in which the resource contents can be acquired may be stored in the content information storage component, and when a notification is given about the relationship between the extracted fusion source content and the plurality of resource contents, the notification component gives a notification about game events in which each of the plurality of resource contents can be acquired.

Consequently, when a resource content is provided, even if the user does not possess other resource contents related to the provided resource content, the user can easily grasp the game event in which that resource content can be acquired.

Also, the number of points possessed by the user may be stored in the user information storage component, and when a notification is given about quests as game events in which the plurality of resource contents can be acquired, the notification component compares the number of points possessed by the user with the number of points consumed in the quest, extracts quests that the user can play from among a plurality of quests, and sends a notification about the extracted quests.

Consequently, when a resource content is provided, even if the user possesses no other resource contents related to the provided resource content, the user can easily grasp the quests that can be played immediately from among those quests in which that resource content can be acquired.

Also, when a fusion source content corresponding to the provided resource content is extracted, the notification component may extracts a fusion source content that satisfies a specific condition and a plurality of resource contents corresponding to the fusion source content that satisfies a specific condition, and sends a notification about the relationship between the fusion source content that satisfies a specific condition and the plurality of resource contents.

Consequently, even if there are many fusion source contents that correspond to the provided resource content, it is possible to narrow down to those fusion source contents that satisfy a specific condition.

One or more embodiments of the present invention include also an information processing device that executes a fusion game in which content fusion is performed using a plurality of resource contents that serve as resources, and fusion target content that serves as a fusion target is generated, said information processing device comprising:

a content information storage component that stores content information in which a plurality of resource contents that have been associated with each other in advance are set corresponding to fusion target content;

a user information storage component that stores user information including content possessed by a user;

a providing component that provides a user any of a plurality of contents including resource contents; and

a notification component that extracts fusion target content corresponding to the provided resource content and a plurality of resource contents corresponding to the fusion target content when the user possesses a resource content provided by the providing component, and sends the user a notification about the relationship between the extracted fusion target content and the plurality of resource contents.

Using this information processing device makes it easy for the user to grasp the relationship between a provided resource content and other contents when the resource content is provided, thus enabling efficient content fusion to be performed using that resource content.

One or more embodiments of the present invention include also a method for a fusion game in which content fusion is performed using fusion source content that serves as a fusion source and resource content that serves as a resource, said method causing a computer to function as:

a content information storage means for storing content information in which a plurality of resource contents that have been associated with each other in advance are set corresponding to fusion source content;

a user information storage means for storing user information including content possessed by a user;

a providing means for providing (granting) a user any of a plurality of contents including resource contents; and

a notification means for extracting (selecting) fusion source content corresponding to the provided resource content and a plurality of resource contents corresponding to the fusion source content when the user possesses a resource content provided by the providing means, and sending the user a notification about the relationship between the extracted fusion source content and the plurality of resource contents.

With this method, when a resource content is provided, the user can easily grasp the relationship between the provided resource content and other contents.

One or more embodiments of the present invention include also a method for a fusion game in which content fusion is performed using a plurality of resource contents that serve as resources, and fusion target content that serves as a fusion target is generated, said method causing a computer to function as:

a content information storage means for storing content information in which a plurality of resource contents that have been associated with each other in advance are set corresponding to fusion target content;

a user information storage means for storing user information including content possessed by a user;

a providing means for providing (granting) a user any of a plurality of contents including resource contents; and

a notification means for extracting (selecting) fusion target content corresponding to the provided resource content and a plurality of resource contents corresponding to the fusion target content when the user possesses a resource content provided by the providing means, and sending the user a notification about the relationship between the extracted fusion target content and the plurality of resource contents.

With this method, when a resource content is provided, the user can easily grasp the relationship between the provided resource content and other contents.

### BRIEF DESCRIPTION OF DRAWINGS

FIG. 1 is a configuration diagram showing an example of an information processing system.

FIG. 2 is a hardware configuration diagram showing an example of a computer.

FIG. 3 is a functional block diagram showing an example of a server device.

FIG. 4 is a functional block diagram showing an example of a client terminal.

FIG. 5 is a flowchart illustrating an operation example of the information processing system.

FIG. 6 is a configuration diagram showing an example of user information.

FIG. 7 is a configuration diagram showing an example of character information.

FIG. 8 is a configuration diagram showing an example of quest information.

FIG. 9 is a configuration diagram showing an example of lottery game information.

FIG. 10 is a conceptual diagram showing an example of a notification screen during character acquisition.

FIG. 11 is a conceptual diagram showing an example of an evolution fusion screen.

### DETAILED DESCRIPTION

Embodiments of the present invention will be described below in detail with reference to the drawings. However, embodiments of the present invention described below are nothing but an example, and are not intended to exclude the application of various modifications or techniques not specifically expressed below. That is, embodiments of the present invention can be modified in various ways without departing from the gist thereof. Also, in the discussion of the drawings below, portions that are the same or similar will be assigned the same or similar reference signs. The drawings are simplified, and do not necessarily match the actual dimensions, proportions, and so forth. From one drawing to the next, there may be portions in which the dimensional relations and proportions are not the same.

The information processing device, method, and information processing system pertaining to one or more embodiments of the present invention will now be described in detail. One or more embodiments of the present invention can be broadly applied to any information processing device, method, information processing system, or the like that employs a game in which content fusion is performed.

### EMBODIMENTS

### <System Configuration>

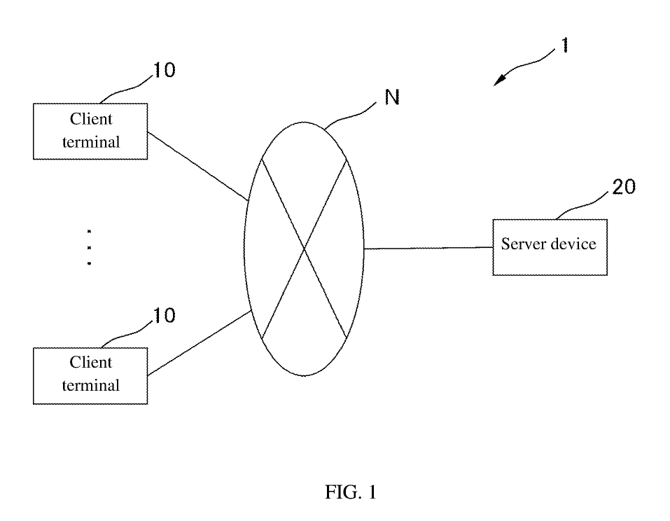

FIG. 1 is a configuration diagram showing an example of the information processing system 1 pertaining to one or more embodiments. As shown in FIG. 1, in the information processing system 1 pertaining to one or more embodiments, one or more client terminals 10 and a server device 20 are connected via a network N.

The client terminal 10 is a terminal device such as a PC, a smartphone, a tablet, or the like operated by a user, or is a terminal device such as a dedicated game device for home or commercial use. The server device 20 manages and controls a game played by the user on the client terminal 10, performs billing processing within the game, and so forth. The network N is the Internet or the like, and includes a mobile wireless base station and the like.

One or more embodiments of the present invention can be applied to a client/server type of information processing system 1 as shown in FIG. 1, as well as to a single game device by additionally providing some way to perform billing processing within the game. It should go without saying that the information processing system 1 in FIG. 1 is just an example, and that various system configurations are possible depending on the application and purpose. For instance, the server device 20 in FIG. 1 may be configured to be distributed among a plurality of computers.

<Hardware Configuration>

### Client Terminal and Server Device

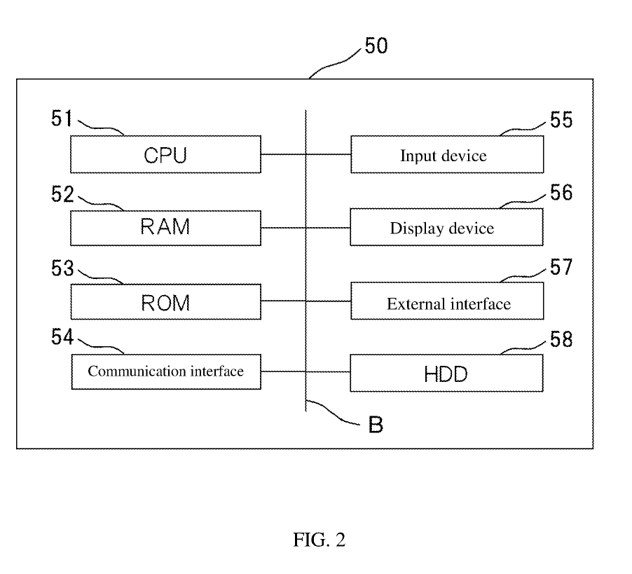

FIG. 2 is a hardware configuration diagram showing an example of the computer 50 pertaining to one or more embodiments. The client terminals 10 and the server device 20 pertaining to one or more embodiments are realized by the computer 50 having the hardware configuration shown in FIG. 2, for example. The computer 50 is an example of an information processing device.

As shown in FIG. 2, the computer 50 comprises a CPU 51, a RAM 52, a ROM 53, a communication interface 54, an input device 55, a display device 56, an external interface 57, an HDD 58, and the like, which are coupled to one another via a bus line B. The input device 55 and the display device 56 may be configured so that they are connected and used only when necessary.

The CPU 51 is an arithmetic apparatus that reads programs and data from a storage device such as the ROM 53 and the HDD 58 to the RAM 52, and executes various kinds of processing based on the read program and data, so as to realize the control and functions of the entire computer. The CPU 51 is also referred to as a processor.

The RAM 52 is an example of a volatile semiconductor memory (storage device) for temporarily holding programs and data, and is also used as a work area when the CPU 51 executes various processing.

The ROM 53 is an example of a nonvolatile semiconductor memory (storage device) that can hold programs and data even when the power is switched off. The ROM 53 stores programs and data such as network settings, OS settings, and BIOS that are executed when the computer 50 is started up.

The communication interface 54 is an interface for connecting the computer 50 to the network N. This allows the computer 50 to perform data communication via the communication interface 54.

The input device 55 is a device used by a user or an administrator to input various signals. The input device 55 is, for example, a touch panel, operation keys or buttons, a keyboard or a mouse, or another such operation device.

The display device 56 is a device for displaying various kinds of information on the screen to a user or a manager. The display device 56 is, for example, a display such as liquid crystal or organic EL.

The external interface 57 is an interface for connecting so as to enable data communication with an external device. This allows the computer 50 to read from and/or write to a recording medium via the external interface 57. The external device is, for example, a recording medium such as a flexible disk, a CD, a DVD, an SD memory card, a USB memory, or the like.

The HDD 58 is an example of a nonvolatile storage device that stores programs and data. The programs and data that are stored include an OS which is basic software for controlling the entire computer, and applications that provide various functions in the OS.

A drive device (such as a solid state drive: SSD) using a flash memory as a storage medium may be used instead of the HDD 58.

The client terminals 10 and the server device 20 pertaining to one or more embodiments can realize various kinds of processing (discussed below) by the computer 50 having the hardware configuration described above.

<Software Configuration>

### Server Device

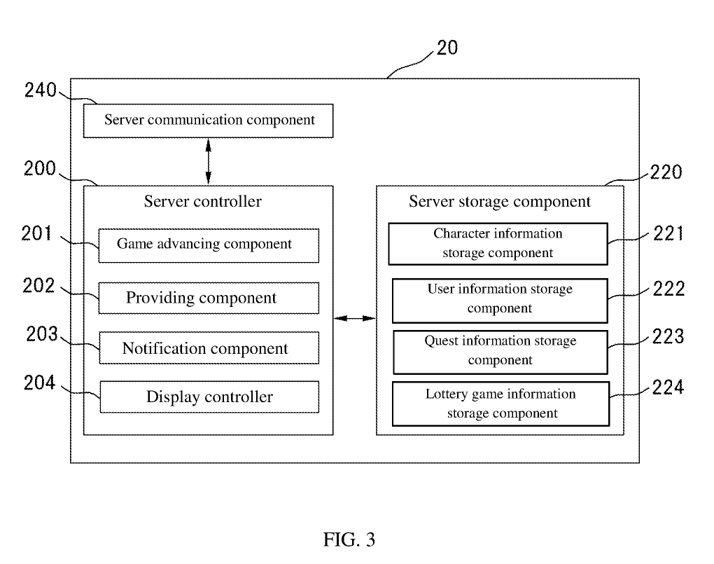

FIG. 3 is a functional block diagram showing an example of the server device 20 pertaining to one or more embodiments. The server device 20 pertaining to one or more embodiments is realized by the functional blocks shown in FIG. 3, for example.

The server device 20 pertaining to one or more embodiments realizes a server controller 200, a server storage component 220, and a server communication component 240.

The server controller 200 has a function of executing processing related to various games. The server controller 200 includes a game advancing component 201, a providing component 202, a notification component 203, and a display controller 204.

The game advancing component 201 controls the progress of various games, such as a battle game, a lottery game, a fusion game, and the like (discussed below), on the basis of game operations received from the user by the client terminal 10.

In a battle game or a lottery game, the granting or providing component 202 provides the user one or more characters from among the plurality of characters configured in character information (discussed below). In other words, the providing component 202 associates one or more characters with the user ID (e.g., identification number). The providing component 202 may store the associated one or more characters to the user information storage component 222. Possessing one or more characters by the user is indicated by associating the one or more characters with the user ID.

When the user has acquired the resource character provided by the providing component 202, the notification component 203 selects or extracts a fusion source character corresponding to the provided resource character and a plurality of resource characters corresponding to that fusion source character, and sends the user a notification about the relationship between the extracted fusion source character and the plurality of resource characters.

The display controller 204 controls screen display on the client terminal 10 according to the progress of the battle game, lottery game, fusion game, etc., by the game advancing component 201, for example.

The server storage component 220 has a function of storing information related to various kinds of games. The server storage component 220 includes a character information storage component 221, a user information storage component 222, a quest information storage component 223, and a lottery game information storage component 224.

The character information storage component 221 is an example of a content information storage component, and stores character information (content information) related to characters, which is an example of content. Various characters used in a battle game, a lottery game, and a fusion game and so forth are configured in the character information stored by the character information storage component 221. In the content information, the plurality of resource characters (resource contents) are associated with each other in advance, and are set corresponding to a fusion source (fusion source content).

The user information storage component 222 stores user information related to the user. The ranking of the user, the various characters possessed by the user, that is, associated to the user ID, the point total, and so forth are configured in the user information stored by the user information storage component 222.

The quest information storage component 223 stores quest information related to quests. Various characters that can be acquired in those quests, the point consumption, and so forth are configured in the quest information stored by the quest information storage component 223.

The lottery game information storage component 224 stores lottery game information related to lottery games. Various characters that can be acquired in those lottery games and so forth are configured in the lottery game information stored by the lottery game information storage component 224.

The server communication component 240 has a function of communicating with the client terminal 10 via the network N.

Client Terminal

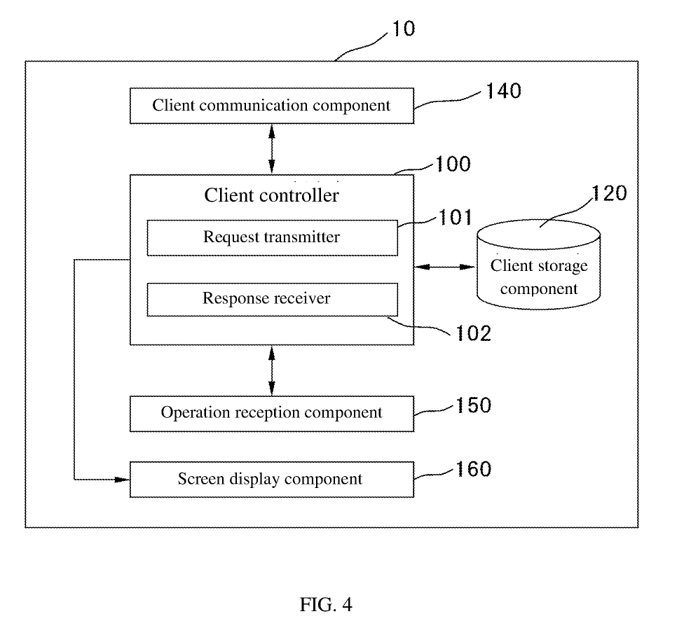

FIG. 4 is a functional block diagram showing an example of a client terminal 10 pertaining to one or more embodiments. The client terminal 10 pertaining to one or more embodiments is realized by the functional blocks shown in FIG. 4, for example.

The client terminal 10 pertaining to one or more embodiments includes a client controller 100, a client storage component 120, a client communication component 140, an operation reception component 150, and a screen display component 160. The client controller 100 includes a request transmitter 101 and a response receiver 102.

The operation reception component 150 receives an operation from a user operating the client terminal 10. Also, the client controller 100 performs processing related to the game in the client terminal 10. The request transmitter 101 transmits a request to the server device 20 based on the particulars of the operation received from the user by the operation reception component 150. The response receiver 102 receives a response, such as a processing result, for a request transmitted by the request transmitter 101 to the server device 20.

The client storage component 120 stores information that is necessary in the client terminal 10. The client communication component 140 communicates with the server device 20. The screen display component 160 displays the screen of the client terminal 10 under control from the server device 20.

As described above, with the information processing system 1 pertaining to one or more embodiments, the server device 20 controls game progress and display, but the client terminal 10 may do so instead. More specifically, the configuration may be such that the game advancing component and/or the display controller may be provided to the client controller 100 of the client terminal 10, while not being provided to the server controller 200 of the server device 20.

Also, the client controller 100 of the client terminal 10 may be a browser type that receives page data written in HTML (Hyper Text Markup Language) or the like, scripts included in the page data, and the like from the server device 20, and performs processing relating to the game. The client controller 100 of the client terminal 10 may also be an application type that performs processing relating to the game based on an installed application.

<Game Overview>

An overview of the game in one or more embodiments will now be given. The games in one or more embodiments include at least a battle game, a lottery game, and a fusion game.

In one or more embodiments, a battle game is a game in which enemy characters appear against a party made up of a plurality of characters, and the various characters that make up the party do battle with the appearing enemy characters.

In this battle game, a plurality of quests are set up, according to the degree of difficulty, for the purpose of defeating the enemy characters. The user can form a party using his own characters, etc., select one of the quests, and engage in battle with the enemy characters.

As a result of this battle, the user may be provided a character if a quest is cleared by defeating the enemy characters. The user can also use the provided character to perform a fusion game.

A lottery game in one or more embodiments is a game in which, when a user operation to execute a character lottery is accepted, a character extracted from a character group subject to the lottery on the basis of lottery conditions is provided to the user. The user can use the provided character to play a battle game or a fusion game.

A fusion game in one or more embodiments is a game in which, when an operation of executing the fusion of characters is received from a user, a character serving as a fusion source (fusion source character) is combined with a character serving as a resource (resource character) to strengthen the ability (strengthening fusion) of the fusion source character, or a fusion source character is grown to the next stage (evolution fusion) and thereby evolved into a fusion target character (evolved character).

The user selects fusion source characters and resource characters from among the characters he possesses, and performs strengthening fusion and evolution fusion. In strengthening fusion, instead of having the resource character taken away from the user, the ability of the fusion source character the user still possesses can be improved, or a new skill can be added. In evolution fusion, all the resource characters that have been associated with a fusion source character are fused with that fusion source character, so that instead of all the resource characters being taken away from the user, he can possess an evolved character that has been grown from the fusion source character.

<Operation>

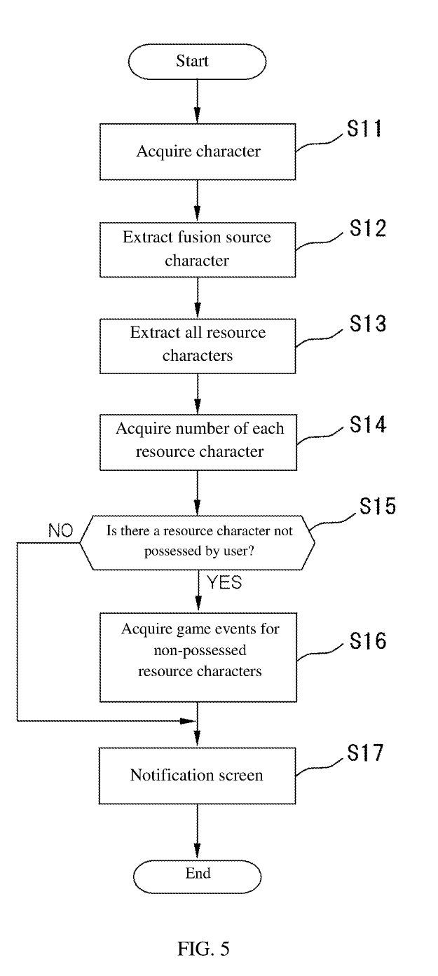

FIG. 5 is a flowchart illustrating an operation example of the information processing system 1 in one or more embodiments.

When the user completes a quest, the game advancing component 201 of the server device 20 allows the user to acquire the resource character provided by the providing component 202 (step S11). At this time, the user information stored in the user information storage component 222 is updated to designate the provided resource character as a character possessed by the user. Then, once the user possesses the resource character, the game advancing component 201 of the server device 20 requests that the notification component 203 execute notification processing at the time of character acquisition.

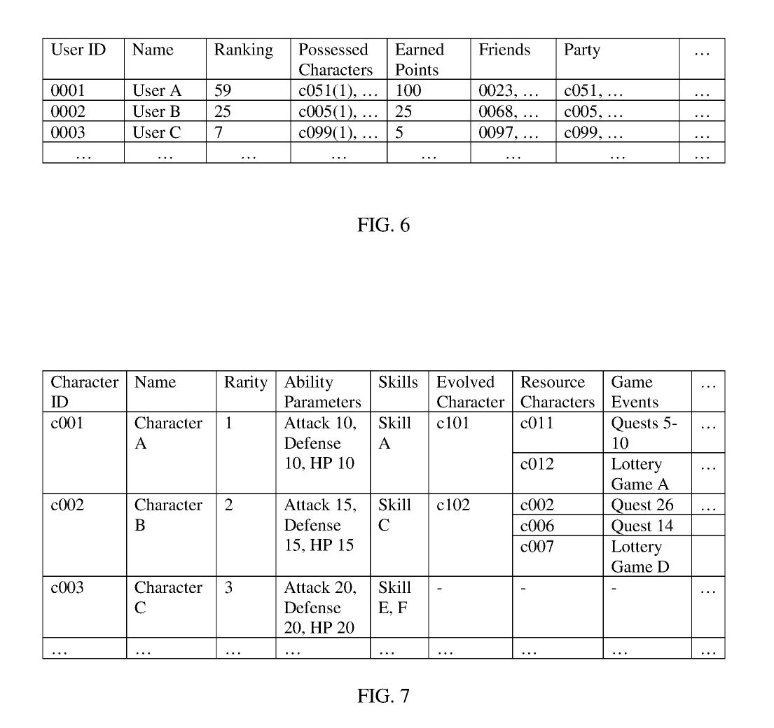

FIG. 6 is a configuration diagram showing an example of user information. The user information shown in FIG. 6 comprises categories such as user ID, name, ranking, possessed characters, earned points, friends, party, and so forth.

User ID is information for uniquely identifying a user. Name is information indicating the user name. Ranking is information indicating the game level of the user. Possessed characters is information indicating the various characters possessed by the user. Here, as shown in parentheses in the figure, the number of possessed characters is also set. Earned points is information indicating the number of game points earned by the user. Friends is information indicating users who are friends. Party is information indicating the characters that make up a party of the user. Number of points possessed by the user is indicated by associating the number of points with the user ID.

Going back to FIG. 5, when the notification component 203 of the server device 20 is requested by the game advancing component 201 to execute notification processing at the time of character acquisition, the fusion source characters corresponding to the resource characters provided by the providing component 202 are all extracted from among a plurality of types of characters (step S12).

In one or more embodiments, the notification component 203 of the server device 20 refers to the user information shown in FIG. 6 and the character information shown in FIG. 7, and extracts only those fusion source characters that meet a specific condition from among the fusion source characters corresponding to the resource character provided by the providing component 202. Here, as the fusion source character that satisfies the specific condition, a fusion source character that has been designated as being a character possessed by the user is extracted (that is, a fusion source character possessed by the user).

FIG. 7 is a configuration diagram showing an example of character information. The character information shown in FIG. 7 comprises categories such as character ID, name, rarity, ability parameters, skills, evolved characters, resource characters, game events, and so forth.

Character ID is information for uniquely identifying various characters, including fusion source characters and resource characters. Name is information indicating the character name. Rarity is information indicating the scarcity value of the character. Here, rarity is set at one of a plurality of levels (for example, one of five levels). Ability parameters is information indicating the abilities of the character. Here, ability values such as attack, defense, and HP are set. Skills is information indicating special skills that can be activated. Skills can be activated by using special characters as resource characters in strengthening fusion. Evolved character is information indicating the post-evolution character which is the fusion target after evolution fusion is performed. It is also possible to set two or more kinds of evolved characters for one character. Resource characters is information indicating characters that will serve as a resource and have been associated with a character serving as a fusion source. These resource characters become characters necessary for evolution fusion. Game events is information indicating the type of game in which a character can be acquired. Here, various quests designated in the quest information stored by the quest information storage component 223, various lottery games designated in lottery game information stored by the lottery game information storage component 224, and so forth are designated as game events.

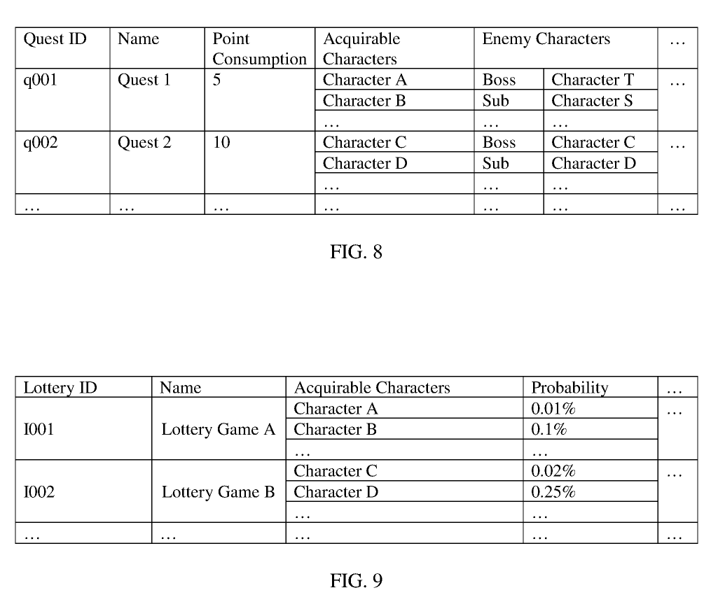

FIG. 8 is a configuration diagram showing an example of quest information. The quest information shown in FIG. 8 comprises categories such as quest ID, name, acquirable characters, point consumption, enemy characters, and so forth.

Quest ID is information for uniquely identifying a quest. Name is information indicating the quest title. Acquirable characters is information indicating various characters that can be acquired based on a predetermined probability when that quest has been completed. Point consumption is information indicating the number of points consumed in playing that quest. Enemy characters is information indicating the various characters that appear in that quest. This includes the enemy character set as the main boss character, and enemy characters set as sub characters other than the boss.

FIG. 9 is a configuration diagram showing an example of lottery game information. The lottery game information shown in FIG. 9 includes categories such as lottery ID, name, acquirable characters, and probability.

Lottery ID is information for uniquely identifying a lottery game. Name is information indicating the lottery game title. Acquirable characters is information indicating the various characters that can be acquired when that lottery game is played. Probability is information indicating the probability of that acquirable character being drawn.

Going back to FIG. 5, when the fusion source character corresponding to the provided resource character is extracted, the notification component 203 of the server device 20 refers to the character information stored in the character information storage component 221 and extracts all of the plurality of resource characters that have been associated with the extracted fusion source character (step S13).

Next, when all of the plurality of resource characters that have been associated with the extracted fusion source character are extracted, the notification component 203 of the server device 20 determines how many of each of the extracted plurality of resource characters are possessed by the user (step S14).

More specifically, the notification component 203 of the server device 20 refers to the user information stored in the user information storage component 222 and searches for each of the plurality of resource characters extracted from among the characters possessed by the user. As a result of this search, if any are included among the characters possessed by the user, the number of resource characters possessed is acquired. On the other hand, if none are included among the characters possessed by the user, the number of possessed resource characters is assumed to be zero.

Next, once the possession status of each of the resource characters is grasped in this manner, the notification component 203 of the server device 20 determines whether or not a resource character not possessed by the user is among the plurality of resource characters extracted by the processing in the above-mentioned step S13 (step S15).

If the result of this determination is that there are no resource characters not possessed by the user among the extracted plurality of resource characters (in other words, if the user possesses all of the extracted plurality of resource characters), the extracted fusion source character is designated as being available for evolution fusion, and the flow proceeds to step S17 (discussed below). On the other hand, if there are resource characters which the user does not possess among the extracted plurality of resource characters, the flow proceeds to step S16 in order to enable evolution fusion to take place for the extracted fusion source character.

Next, if there are resource characters that the user does not possess among the extracted plurality of resource characters, the notification component 203 of the server device 20 refers to the character information stored in the character information storage component 221, and acquires the game events corresponding to the resource characters that are not in the user's possession (step S16).

In one or more embodiments, when a plurality of quests are set as game events in the character information, or when a plurality of quests have been acquired as game events, it is possible to narrow down those quests. That is, the notification component 203 refers to the user information and the quest information, compares the number of points possessed by the user against the number of points that will be consumed in a quest, and may extract those quests that the user can play immediately from among the plurality of quests. That is, quests designated as having fewer points to be consumed than the number of points possessed by the user may be extracted.

Next, based on the various pieces of information acquired in this manner, the fusion source character extracted by the above-mentioned processing in step S12, and the resource characters extracted by the above-mentioned processing in step S13, the notification component 203 of the server device 20 sends a notification about the relationship between the extracted fusion source character and the plurality of resource characters to the user (step S17).

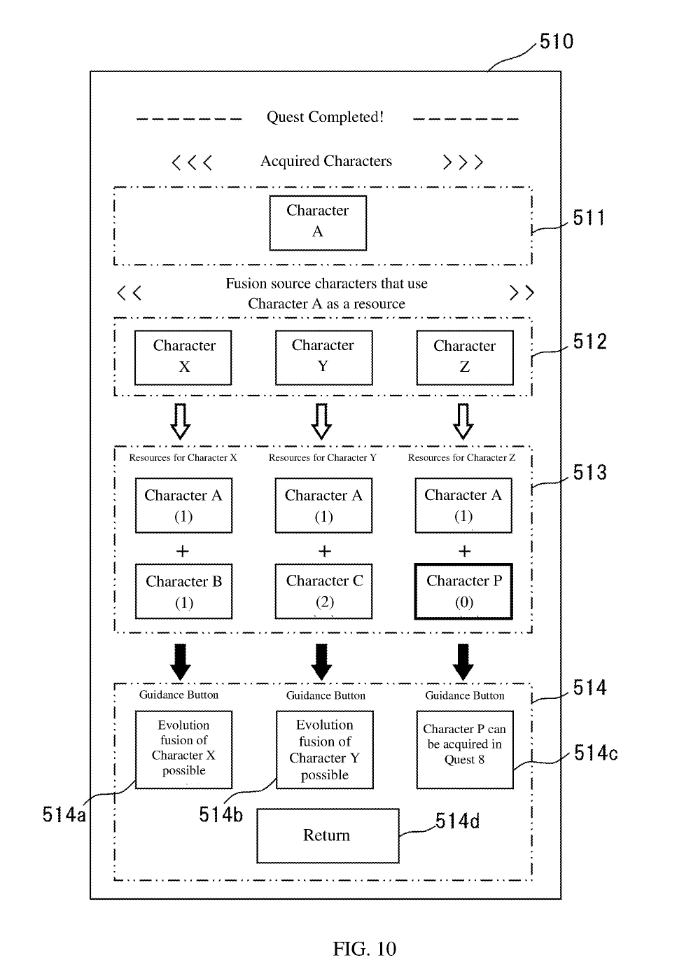

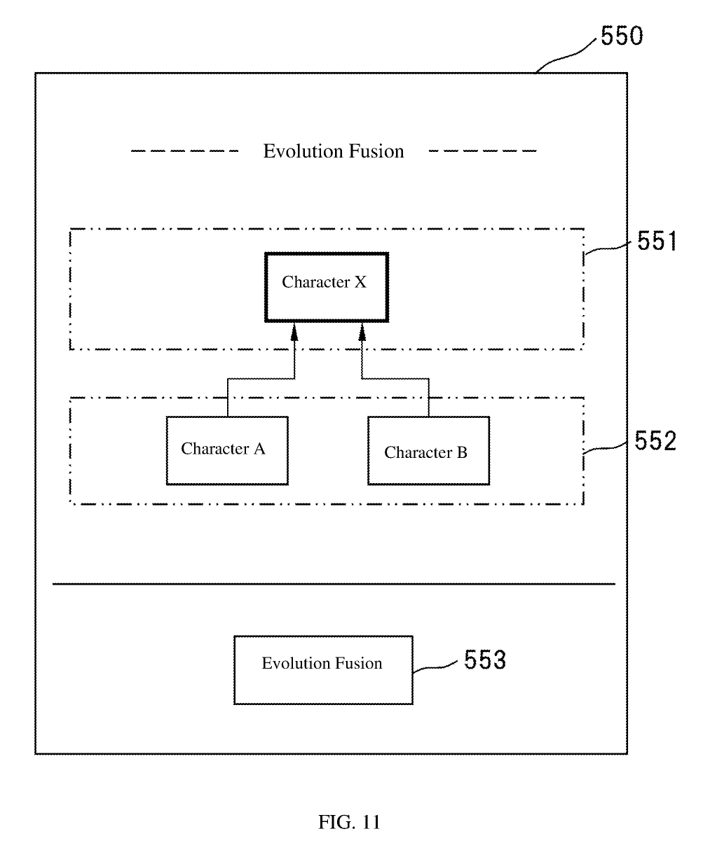

In one or more embodiments, notification is given by a notification screen as shown in FIG. 10. Therefore, when there is a request from the notification component 203 to execute screen display control, the display controller 204 performs control to display the notification screen on the screen display component 160 of the client terminal 10.

FIG. 10 is a conceptual diagram showing a concept of a notification screen at the time of character acquisition. A notification screen 510 at the time of character acquisition displays an acquired character display area 511, a fusion source character display area 512, a resource character display area 513, and a guidance action display area 514.

In the acquired character display area 511 is displayed the resource character acquired by the user (“character A”), from among the acquirable characters set in the quest information stored by the quest information storage component 223.

In the fusion source character display area 512 is displayed a list of fusion source characters (“character X,” “character Y,” and “character Z”), extracted by the above-described processing of step S2 from among the possessed characters that the user possesses.

In the resource character display area 513, a plurality of resource characters extracted by the above-mentioned processing of step S13 are displayed corresponding to the respective fusion source characters displayed in the fusion source character display area 512.

Here, a plurality of resource characters “character A” and “character B” are displayed corresponding to “character X,” which is a fusion source character. A plurality of resource characters “character A” and “character C” are displayed corresponding to “character Y,” which is a fusion source character. A plurality of resource characters “character A” and “character P” are displayed corresponding to “character Z,” which is a fusion source character.

In the resource character display area 513, based on the number of each possessed resource character acquired by the above-mentioned processing of step S14, the number of characters possessed by the user is displayed corresponding to the respective extracted plurality of resource characters (shown in parentheses in the drawing).

In the guidance action display area 514 are displayed operation buttons for guiding the user to the next action that can be performed as a result of the user acquiring the resource character displayed in the acquired character display area 511.

Here, guidance buttons 514a and 514b for guiding evolution fusion are displayed corresponding to “character X” and “character Y,” a guidance button 514c for guiding to game events is displayed corresponding to “character Z,” and an operation button 514d for returning to the initial screen is also displayed.

The guidance button 514a displays that the evolution fusion of “character X” is possible as the next performable action since the user possesses all of the plurality of resource characters “character A” and “character B” corresponding to “character X,” which is a fusion source character.

The guidance button 514b displays that the evolution fusion of “character Y” is possible as the next performable action since the user possesses all of the plurality of resource characters “character A” and “character C” corresponding to “character Y,” which is a fusion source character.

In order to enable the evolution fusion of “character Z,” the guidance button 514c displays “quest 8” as the next performable action with which it is possible to acquire a resource character “character P,” which is not possessed by the user, based on game events for non-possessed resource characters that are acquired by the above-mentioned processing of step S16.

When the guidance button 514a or 514b is pressed by the user, the notification screen 510 transitions to the evolution fusion screen 550 shown in FIG. 11. On the evolution fusion screen 550, “character X,” which is the fusion source character extracted by the above-mentioned processing of step S12, is displayed in the fusion source character display area 551, and “character A” and “character B,” which are the plurality of resource characters extracted by the above-mentioned processing of step S13, are displayed in the resource character display area 552. Then, when the operation button 553 is pressed by the user, evolution fusion can be performed immediately.

When the guidance button 514c is pressed by the user, the notification screen 510 transitions to a battle game screen (not shown). Then, in order to acquire the missing “character P,” the user can immediately play “quest 8” on this battle game screen.

As discussed above, with the information processing system 1 in one or more embodiments, displaying the notification screen 510 shown in FIG. 10 when a resource character is provided by the providing component 202 makes it easy for the user to grasp the relationship between the fusion source character corresponding to the provided resource character and the plurality of resource characters necessary for the evolution fusion of the fusion source character. As a result, it is possible to efficiently fuse characters using the provided resource characters.

### Additional Embodiments

The previously-described embodiments are intended to facilitate an understanding of the present invention and should not be construed as limiting the present invention. The present invention can be modified and improved upon without departing from the spirit of the invention, and equivalents thereof are also included in the present invention. In particular, one or more embodiments described below are also encompassed by the present invention.

<Notification Component>

In the previously-described embodiments, an example was given in which the number of resource characters possessed by the player is acquired by the above-mentioned processing of step S14, and the numbers corresponding to each of the extracted resource characters are displayed on the notification screen 510 shown in FIG. 10, but it is also possible to not display the number of possessed resource characters.

In the previously-described embodiments, an example was given in which game events for resource characters that are not possessed are acquired by the above-mentioned processing of step S16, and quests or the like with which non-possessed resource characters can be acquired are displayed on the basis of the acquired game events, but it is also possible to not display quests or the like with which non-possessed resource characters can be acquired.

In the previously-described embodiments, an example was given in which a display for guiding to a fusion game is displayed on the notification screen 510 shown in FIG. 10 when the user possesses all of the resource characters corresponding to the fusion source character extracted by the above-mentioned processing of step S12, but it is also possible to not display the guidance to the fusion game.

<Fusion Game>

In the previously-described embodiments, an example was given of a fusion game in which all of the plurality of resource characters that have been associated with the fusion source character in advance are fused to change the fusion source character into an evolved character, but the present invention is not limited to or by this.

For example, instead of fusing resource characters to a fusion source character, a fusion game may be executed in which all the resource characters that have been associated with each other are fused together to generate an evolved character that serves as a fusion target (fusion target character).

In this case, for example, the character information storage component 221 stores character information in which a plurality of resource characters that have been associated in advance are designated corresponding to a fusion target character. Then, when the user has possessed the resource character provided by the providing component 202, the notification component 203 may refer to this character information, and extract or select a fusion target character corresponding to the provided resource character and a plurality of resource characters corresponding to the fusion target character, and then notify the user about the relationship between the extracted fusion target character and the plurality of resource characters.

<Specific Conditions>

In the previously-described embodiments, an example was given in which the fusion source character is narrowed down by using the fact that the user is already in possession as a specific condition in the above-mentioned processing of step S12, but the present invention is not limited to or by this.

For example, various conditions may be applied, such as that the rarity of the fusion source character be at or above a specific value, that the number of times of use in character fusion be at or above a specific number of times, or that there be a specific number of missing resource characters.

Also, rather than narrowing down the fusion source character depending on a specific condition, the condition may be eliminated altogether. In this case, the user may be asked to choose one of the plurality of fusion source characters extracted by the above-mentioned processing of step S12.

<Game Events>

In the previously-described embodiments, an example was given in which, when acquiring a game event in which a non-possessed resource character can be acquired in the above-mentioned processing of step S16, quests that the user can play immediately are narrowed down from among a plurality of quests according to how many points the user has, but the present invention is not limited to or by this. For example, rather than narrowing down quests according to how many points the user has, the user may be asked to choose one of a plurality of quests.

Also, in the previously-described embodiments, even if the user is able to acquire a plurality of lottery games and quests as game events, the quests or lottery games that can be played immediately by the user may be narrowed down or the user may be asked to choose one. Likewise, in the previously-described embodiments, even if the user is able to acquire a plurality of lottery games as game events, the lottery games that can be played immediately by the user may be narrowed down or the user may be asked to choose one.

<Splitting of Evolved Characters>

In the previously-described embodiments, in the determination processing of step S15, if it is determined that there is a resource character which the user does not possess among the plurality of resource characters extracted by the processing of step S13, the user may be notified that the non-possessed resource character may be acquired by splitting up an evolved character in the user's possession.

For example, if the user has acquired the evolved character “character W” by using resource characters “character P” and “character T” for evolution fusion, if the evolved “character W” is made to retrogress, instead of the user losing “character W,” it is split up into “character P” and “character T,” which the user then possesses. In this case, on the notification screen in FIG. 10, notification may be given that a missing resource character “character P” can be obtained by splitting up the evolved character possessed by the user “character “W.” Furthermore, in this case, when the user extracts the guidance button corresponding to “character P,” the screen will transition to a splitting game. Consequently, “character W” can be split up right away to obtain the lacking “character P.”

<Content>

In the previously-described embodiments, a character is set as character information, but the content is not limited to this. For example, the content may be an item, a card, a figure, an avatar, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 information processing system
10 client terminal
20 server device
50 computer
51 CPU
52 RAM
53 ROM
54 communication interface
55 input device
56 display device
57 external interface
58 hard disk drive
100 client controller
101 request transmitter
102 response receiver
120 client storage component
140 client communication component
150 operation reception component
160 screen display component
200 server controller
201 game advancing component
202 providing component
203 notification component
204 display controller
220 server storage component
221 character information storage component
222 user information storage component
223 quest information storage component
224 lottery game information storage component
240 server communication component
510 notification screen
511 acquired character display area
512 fusion source character display area
513 resource character display area
514 guidance action display area
514a guidance button
514b guidance button
514c guidance button
514d operation button
550 evolution fusion screen
551 fusion source character display area
552 resource character display area
553 operation button
B bus line
N network

1. An information processing device that executes a fusion game, comprising:
a content information storage that stores content information in which a plurality of resource contents, associated with each other in advance, are set corresponding to a fusion source content;
a user information storage that stores user information including content associated with a user ID;
a processor that:
associates at least one of the plurality of contents, wherein the plurality of contents include any of the resource contents, with the user ID;
when one of the resource contents is associated with the user ID, extracts:
the fusion source content corresponding to the one resource content associated with the user ID, and
the resource contents corresponding to the extracted fusion source content, and
sends a notification about the relationship between the extracted fusion source content and the extracted plurality of resource contents.

2. The information processing device according to claim 1, wherein the notification includes a possession status with respect to each of the extracted plurality of resource contents, and the possession status indicates whether the resource content associated with the user ID or not.

3. The information processing device according to claim 2,
wherein the processor further controls a progress of the fusion game in which the resource contents, each of which is associated with the user ID and corresponding to the fusion source content, are combined with the fusion source content,
wherein the notification further includes a guide to the fusion game when the possession status indicates that each of all the extracted plurality of resource contents corresponding to the fusion source content is associated with the user ID.

4. The information processing device according to claim 1,
wherein the content information storage further stores game events information that indicates game events where each of the resource contents is acquired, and
when the processor displays the notification about the relationship between the extracted fusion source content and the extracted plurality of resource contents, the notification further includes the game events information that indicates the game events where each of the extracted plurality of resource contents is acquired.

5. The information processing device according to claim 4,
wherein the user information storage further stores a number of points associated with the user ID, and
when the notification includes the game events information that indicates a quest as one of the game events, the processor further:
compares the number of points associated with the user ID with the number of points consumed in the quest;
extracts quests affordable to play from among a plurality of quests; and
sends the extracted quests.

6. The information processing device according to claim 1,
wherein, when the processor extracts the fusion source content corresponding to the one resource content associated with the user ID, the processor:
extracts the fusion source content that further satisfies a specific condition and the plurality of resource contents corresponding to the extracted fusion source content that satisfies the specific condition; and
sends the notification about the relationship between the extracted fusion source content that satisfies the specific condition and the extracted plurality of resource contents.

7. An information processing device that executes a fusion game comprising:
a content information storage that stores content information in which a plurality of resource contents associated with each other in advance are set corresponding to a fusion target content;
a user information storage that stores user information including content associated with a user ID;
a processor that:
associates at least one of the plurality of contents, wherein the plurality of contents include any of the resource contents, with the user ID;
when one of the resource contents is associated with the user ID, extracts;
the fusion target content corresponding to the one resource content associated with the user ID, and
the resource contents corresponding to the extracted fusion target content, and
sends a notification about the relationship between the extracted fusion target content and the extracted plurality of resource contents.

8. A method causing a computer to execute a fusion game comprising:
storing content information in which a plurality of resource contents associated with each other in advance are set corresponding to a fusion source content;
storing user information including content associated with a user ID;
associating at least one of the plurality of contents, wherein the plurality of contents include any of the resource contents, with the user ID;
when one of the resource contents is associated with the user ID, extracting:
the fusion source content corresponding to the one resource content associated with the user ID, and
the resource contents corresponding to the fusion source content, and
sending a notification about the relationship between the extracted fusion source content and the extracted plurality of resource contents.

9. A method causing a computer to execute a fusion game comprising:
storing content information in which a plurality of resource contents associated with each other in advance are set corresponding to a fusion target content;
storing user information including content associated with a user ID;
associating at least one of the plurality of contents, wherein the plurality of contents include any of the resource contents, with the user ID; and
when one of the resource contents is associated with the user ID, extracting:
the fusion target content corresponding to the one resource content associated with the user ID, and
the resource contents corresponding to the fusion target content, and
sending a notification about the relationship between the extracted fusion target content and the extracted plurality of resource contents.
